(19) United States
(12) Patent Application Publication
(10) Pub. No.: US 2019/0236737 A1
(43) Pub. Date: Aug. 1, 2019

(54) SOCIAL NETWORK SERVER AND METHODS THEREIN

(71) Applicant: Afield AB, Göteborg (SE)

(72) Inventor: Kennedy NWUP, Göteborg (SE)

(21) Appl. No.: 16/312,118

(22) PCT Filed: Jun. 20, 2017
(86) PCT No.: PCT/EP2017/065090

§ 371 Date: Dec. 20, 2018

(30) Foreign Application Priority Data
Jun. 22, 2016 (SE) 1650897-0
Aug. 19, 2016 (SE) 1651119-8

(51) Int. Cl. G06Q 50/26; G06Q 50/00; G06F 16/387; G06F 16/909

(52) U.S. Cl. CPC G06Q 50/26; G06F 16/909; G06F 16/387; G06Q 50/01

(57) ABSTRACT

The disclosure proposes a method and electronic device for generating and displaying a graphical user interface, detecting an issue data input, the issue data input is associated with a creation of an issue, or registration of an interest in an existing created issue, where the issue is relating to an identified societal issue and detecting a project data input, the project data input is associated with a creation of a project or registration of an interest in an existing created project, the project data input from the user is indicating that the project is related to an issue and aims to address and/or contribute to the issue.

### TECHNICAL FIELD

The disclosure pertains to the field of social networks and in particular to a method, at an electronic device generating a graphical user interface for social societal information sharing and for providing user interaction for sharing information between users.

### BACKGROUND

Today citizens of a country or e.g. in a city may discover or experience some societal issues that they seek information to, or that they want to know more about. It may also relate to societal issues that needs a solution. It could for instance be related to an environmental issue like an oil leakage in a bay and as a citizen you may want to know more what is happening, and understand what the state or city is doing to prevent further damage. You may want to volunteer to help, or, if you run a business, engage in a project to e.g. help clean up the beaches from oil etc.

Today a citizen can e.g. get information from a newspaper or use an Internet connected computer or smartphone with a web browser to get information via home page of an authority or public sector organisation, institution or official body or from an individual or special interest group stakeholder. A citizen can interact using mail, e-mail or a telephone to contact e.g. an authority or public sector organisation, institution or official body and/or an individual or special interest group stakeholder to get, and exchange, information regarding an societal issue or project. There are examples of e.g. authorities that use social media, such as Facebook, Twitter and blogs e.g. for one-way of communication of information about what is happening in e.g. a city. This kind of communication helps to spread information between different parties. Often so called hashtags are used to associate or “tag” a certain topic with information communicated by other parties in a certain social media.

For societal issues there are plural stake holders. A stakeholder may e.g. be an individual citizen or a special interest group. A stakeholder may also be e.g. an authority or a public sector institution or organization. All may have an interest in a certain societal issue and may all have something to contribute with that could solve the societal issue.

Often today when there is a societal issue to be solved, the different parties or stakeholders often communicate and work independently and far from each other. One party may not know about the other and maybe it is just one party, e.g. the authority responsible for a certain societal issue that is up to date with most information regarding the societal issue.

### SUMMARY

An object of the present disclosure is to provide a method and a device which seek to mitigate, alleviate, or eliminate one or more of the above-identified deficiencies in the art and disadvantages singly or in any combination.

Today there is a demand for more efficient ways in solving societal issues and for a more transparent way of communicating information between parties and stakeholders when solving societal issues. In this disclosure, a solution to the problem outlined above is proposed.

The disclosure proposes a method, at an electronic device for social societal information sharing. The method comprising generating a graphical user interface for displaying societal social media information and for providing user interaction. The method further comprising displaying the graphical user interface. The method further comprising detecting an issue data inputted by a user via the graphical user interface, the issue data input is associated with a creation of an issue, or registration of an interest in an existing created issue, where the issue is relating to an identified societal issue and displaying the issue data via the graphical user interface. The method further comprising detecting a project data inputted by a user via the graphical user interface, the project data being associated with a creation of project or registration of an interest in an existing created project, the project data input from the user is indicating that the project is related to an existing created issue and aims to address the identified societal issue. The method further comprising linking the project with the issue by utilizing data input from the user that is indicating that the project is related to an existing created issue and storing the link association in a memory in the electronic device and displaying the project data via the graphical user interface and displaying the link association between the project and the issue via the graphical user interface. A user of the method can hence e.g. get information about a certain societal issue and the projects that are associated with the issue in a simplified and transparent way. The user may also create an issue and/or a project that is related to an issue. This enables a structured and organized way to associate issues and projects.

According to some aspects of the disclosure the method further comprising detecting an event data inputted by a user via the graphical user interface, the event data input associated with a creation of an event that is related to the issue and/or the project and displaying the event data via the graphical user interface and enabling any user to register, via the graphical user interface, an interest in following, and being updated on information relating to the event. A user of the method can hence get information about events that are related to projects and/or issues. This enables a structured and organized way to associate issues, projects and events.

According to some aspects of the disclosure the method further comprising initiating communication of the issue data, project data and/or event data from the electronic device to any user. The communication enables that a user can be updated on events that the user is interested in.

According to some aspects of the disclosure the method further comprising initiating communication of the issue data, project data and/or event data from the electronic device to any user, the issue data, project data and/or event data comprising visual data such as video, live streamed video or television, images or any visual media. This enables any user to see e.g. changes and updates.

According to some aspects of the disclosure the method further comprising initiating communication of the issue data, project data and/or event data from the electronic device to a restricted predefined group of users. Hence only certain users can see the data.

According to some aspects of the disclosure the method further comprising storing the issue data, the project data and/or the event data and any update data input related to such data, in a memory at the electronic device. The data is hence retained for further processing.

According to some aspects of the disclosure the method further comprising detecting an update data input of the issue data, the project data and/or the event data from a user via the graphical user interface, the update data input being associated with a updating of information of the issue data, the project data and/or the event data and at least one of the issue data, the project data and/or the event data being associated with each other and storing the update event data input in a memory at the electronic device. Hence, a user of the method can input an update of the issue, project and/or the event via the graphical user interface at any time and the update data is maintained in a memory of the electronic device for further processing.

According to some aspects of the disclosure the method further comprising initiating communication of the issue data, the project data and/or the event data from the electronic device to the public sector organisation, institution or official body and/or the individual or special interest group stakeholder. The communication of the data to different parties enables transparent crowd monitoring of societal issues, projects and events. A user of the method can hence e.g. get information about a certain societal issue and the projects that are associated with the issue in a simplified and transparent way.

According to some aspects of the disclosure the method further comprising initiating communication of the issue data, the project data and/or the the event data from the electronic device to any social media platform or digital channel. This means that data can be processed and used in other platforms.

According to some aspects of the disclosure the method further comprising detecting an information request data inputted by a user via the graphical user interface, the user requesting to be updated on information relating to an issue, a project and/or an event and registering the information request data and storing the information request data in a memory at the electronic device and initiating communication of information to a user relating to requested data relating to an issue, a project and/or an event. A user can hence request to be registered in order to receive information of interest relating to an issue, a project and/or an event. The electronic device can communicate the requested information accordingly.

According to some aspects of the disclosure the method further comprising detecting position data and linking issue data, project data and/or event data with position data and storing the link association in a memory in the electronic device. With this information a user can e.g. get data related to an issue, project and/or event at a certain location. The position can e.g. be the user's current position or any position. According to some aspects of the disclosure the method further comprising storing the positioning data in a memory at the electronic device.

According to some aspects of the disclosure the method further comprising detecting a search query inputted by a user via the graphical user interface, the search query is either related to a specific issue data, project data and/or event data or the search query is based on a position data for a certain geographic location for finding any issue data, project data and/or event data in relation to the geographic location. Then processing the search query input and retrieving data from the memory of the electronic device and displaying a search result via the graphical user interface based on the search query input. Hence, a user can find relevant issue data, project data and/or event data using either keywords or position data.

According to some aspects of the disclosure the method further comprising detecting position data and determining, by using the position data, if any issue data, project data and/or event data exists that is associated with the position data or within a predetermined distance from the geographic location defined by the position data. Further the method comprising collecting any existing issue data, project data and/or event data dependent on the position data and initiating communication of the existing issue data, project data and/or event data to any user, public sector organisation, institution or official body and/or an individual or special interest group stakeholder and displaying in the graphical user interface, the issue, project and/or event on a map. This means that any user can get updates based the geographic location of an issue, project and/or event.

The disclosure further proposes an electronic device configured for generating a graphical user interface, and for providing user interaction. The electronic device comprising a memory and a communication interface for providing communication with at least one server. The electronic device further comprising a processing circuitry configured to cause the electronic device to generate a graphical user interface for displaying societal social media information and for providing user interaction. The processing circuitry is further configured to cause the electronic device to display the graphical user interface. The processing circuitry is further configured to cause the electronic device to detect an issue data inputted by a user via the graphical user interface, the issue data input associated with a creation of an issue, or registration of an interest in an existing created issue, where the issue is relating to an identified societal issue and display the issue data via the graphical user interface. The processing circuitry is further configured to cause the electronic device to detect a project data inputted by a user via the graphical user interface, the project data being associated with a creation of project or registration of an interest in an existing created project, the project data input from the user is indicating that the project is related to an existing created issue and aims to address the identified societal issue. The processing circuitry is further configured to cause the electronic device to utilize data input from the user that is indicating that the project is related to an existing created issue and linking the project with the issue and store the link association in a memory in the electronic device and display the project data via the graphical user interface, and further to display the link association between the project and the issue via the graphical user interface. A user of the method can hence e.g. get information about a certain societal issue and the projects that are associated with the issue in a simplified and transparent way. The user may also create an issue and/or a project that is related to an issue. This enables a structured and organized way to associate issues and projects.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates an example of how electronic devices are connected according to some aspects of the disclosure.

FIG. 2 illustrates a flow chart over the method steps according to some aspects of the disclosure.

FIG. 3 illustrates how data is inputted and communicated according to some aspects of the disclosure.

FIG. 4 illustrates a graphical user interface according to some aspects of the disclosure.

### DETAILED DESCRIPTION

Aspects of the present disclosure will be described more fully hereinafter with reference to the accompanying drawings. The method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

Today plurality of ways to communicate information is present and anyone can use the Internet and social media to share information. This opens up for visualizing any information for anyone. There are examples of e.g. authorities that use social media, such as Facebook, Twitter and blogs e.g. for one way of communication of information about what is happening in e.g. a city. This kind of communication helps to spread information between different parties. Often so called hashtags are used to associate or “tag” a certain topic with information communicated by other parties in a certain social media.

For societal issues there are plural stake holders. A stakeholder may e.g. be an individual citizen or a special interest group. A stakeholder may also be e.g. an authority or a public sector institution or organization. All may have an interest in a certain societal issue and may all have something to contribute with that could solve the societal issue.

Often today when there is a societal issue to be solved the different parties or stakeholders communicate and work independently and far from each other. One party may not know about the other and maybe it is just one party, e.g. the authority responsible for a certain societal issue that is up to date with information regarding the societal issue. A project that aims to solve a societal issue, or an event related to a societal issue, may exist without any association and with none or very little insight for any other party.

The inventor has identified that there is a need for a solution where a societal issue is closely linked with a project, or projects, that aims to solve the identified societal issue and that this link, or association, is visualized for any user in order for any user to get any related information available that is associated with an issue or project in a transparent, organized way. The user can be an individual citizen, any physical or legal person, or a special interest group but also an authority or a public sector institution or organization or any stakeholder.

The inventor proposes a method and device, for example a system and/or online tool whereby information can be transparently disseminated to any user, individual stakeholder or group of stakeholders, where the disseminated information relates to a prospective or existing project, service or measure that aims to address a societal need or issue. The stakeholders can be consulted or informed of prospective or existing projects via a massively-linked network of users. According to some aspects of the disclosure the method and device comprising a massively-linked network or platform that enables information to be widely disseminated to stakeholders in a manner that is frequently updateable, is conducive to receiving feedback or comment from stakeholders and that is searchable.

The inventor further propose a method and device, e.g. in form of an online tool, that enable public, private and third sector organisations to receive feedback or mass-monitoring information on projects, measures or interventions that aim to address a societal need or issue. Further that an individual or interest group is able to register interest in an issue relating to an identified societal issue or need. By means of the method and device a dialogue between said individual or interest group and said body can take place, for the purpose of increasing knowledge and transparency around a societal issue. The information regarding the planning, execution and completion of projects, measures or interventions designed to address said societal issue, is according to the disclosure rapidly disseminated, updated and received by said individual or interest group.

The disclosure proposes a method at an electronic device that now will be described in more detail with help from the accompanying figures.

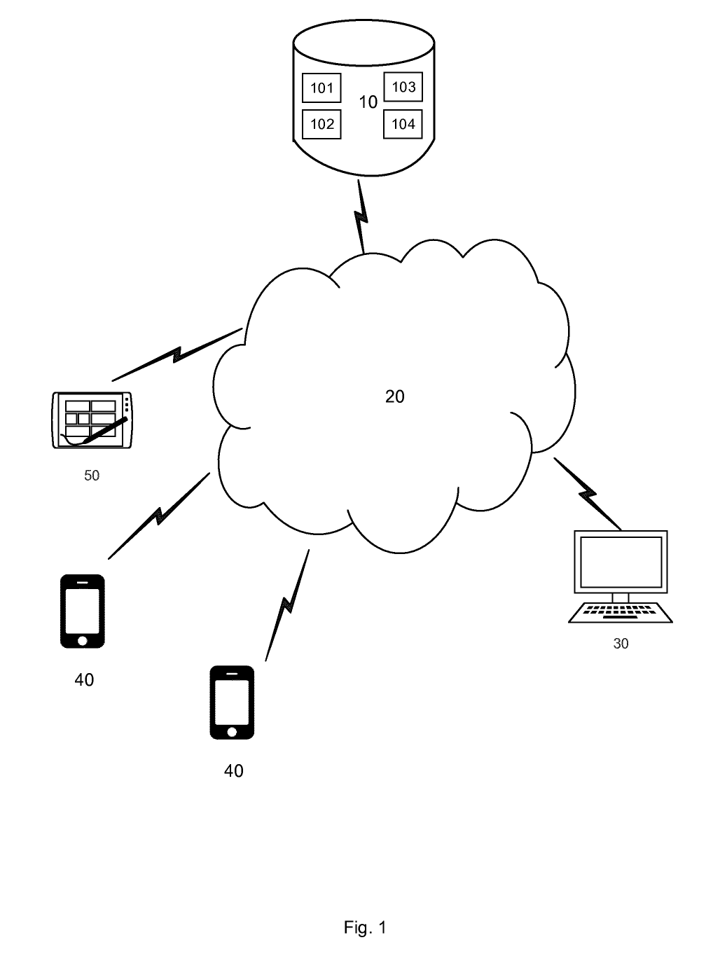

FIG. 1 illustrates a system where the proposed method and device may be implemented. The system comprises an electronic device 10, 30, 40, 50. The electronic device 10, 30, 40, 50 comprises a memory 101, a communication interface 102 and a processing circuitry 103. The electronic device 10, 30, 40, 50 can also comprise a sensor 104. The electronic device may be a personal computer 30, a smartphone 40, a tablet 50 or any similar electronic device. The electronic device may be a server 10, in particular a graphical user interface server 10 or social network server 10. The electronic device may be a server located in the cloud 10. The electronic device 10, 30, 40, 50 is connected to a network 20 such as the Internet via the communication interface 102. The electronic device 10, 30, 40, 50 is connected to one or more other electronic devices 10, 30, 40, 50 via the network 20. The memory 101 can be any data storage for retaining data. The communication interface 102 may be utilizing wireless or wired connection. A user may utilize any electronic device 10, 30, 40, 50. The sensor 104 can be a Global Positioning System, GPS, receiver for determining the geographical position and for providing position data to the electronic device 10, 30, 40, 50 or any other sensor for determining the geographical position.

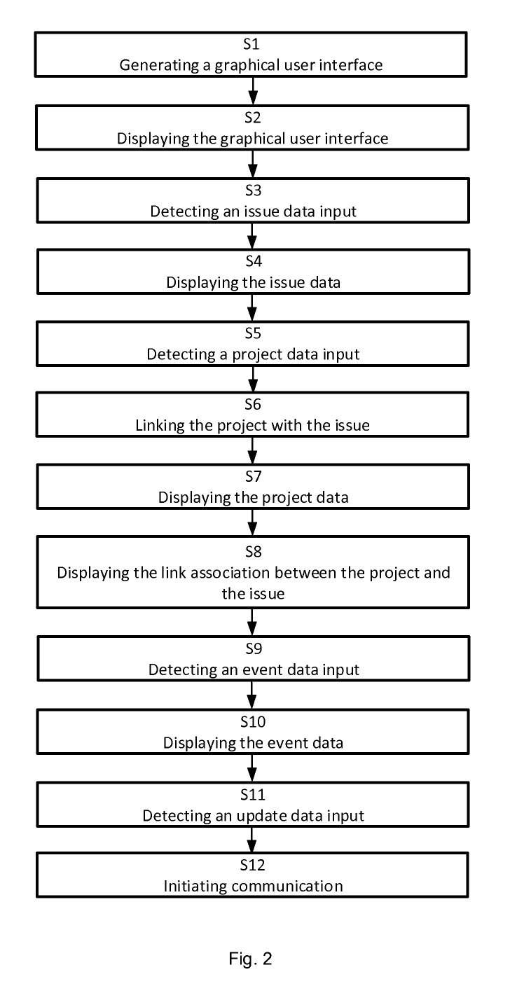

A method performed in an electronic device 10, 30, 40, 50 e.g. a server 10, will now be described with reference to the blocks S1 to S12 of the flow chart in FIG. 2.

The method comprising generating a graphical user interface S1 for displaying societal social media information and for providing user interaction. Societal social media information can be any information such as text, image, sound, video, message, animation and/or augmented reality that is intended for sharing with others and addressing a societal issue, societal project or societal event. The graphical user interface 100 that is generated is for displaying information but also for providing user interaction. The graphical user interface 100 can be displayed on any electronic device 10, 30, 40, 50 including another electronic device 10, 30, 40, 50 connected via a network 20. According to some aspects of the disclosure the graphical user interface 100 is generated by the processing circuitry 103 of the electronic device 10, 30, 40, 50. According to some aspects of the disclosure the graphical user interface 100 is generated according to instructions by a user given in a software program that is used for generating the graphical user interface 100. The software program may be running on a computer that is connected to the electronic device 10, 30, 40, 50. The electronic device can be a graphical user interface 100 server 10.

The method further comprising displaying the graphical user interface S2. According to some aspects of the disclosure the graphical user interface 100 is adapted for being displayed to a user via a web interface or a mobile application interface on the electronic device 10, 30, 40, 50.

The method further comprising detecting an issue data input S3 from a user via the graphical user interface 100, the issue data input is associated with a creation of an issue, or registration of an interest in an existing created issue, where the issue is relating to an identified societal issue and displaying the issue data S4 via the graphical user interface 100. Issue data can be any data that is related but not limited to a societal issue. A societal issue can also be an organizational issue or a company issue that has an societal impact. Issue data including e.g. a text and/or an image describing an environmental disaster in a city. Issue data can also be e.g. registration information relating to an existing issue. Issue data can be registration information associated to certain issue that the user wants to know more and be updated about. In one example a user has identified a societal issue such as an oil leakage in a bay. The user cannot find any existing issue and therefore creates an issue relating to the oil leakage. This can e.g. be made by creating an issue named “Tanker accident Issue” and further issue data including a text describing the date and location and an observation what the user see or by adding a picture taken visualizing the tanker and the oil leakage. In one example the oil leakage issue exists, and the user that wants to know more about this issue register an interest in the issue.

According to some aspects of the disclosure the detecting is input by a user touching a touch display. According to one aspect of the disclosure the detecting is input by a user selecting an object by clicking on a mouse on a computer device. Detecting can be any kind of user input such as selecting an object on a TV-screen using a remote control or, using gesture input or voice input.

The method further comprising detecting a project data input S5 from a user via the graphical user interface 100. Project data is relating to any project information, or a registration of an interest in an existing created project. Project data may e.g. be a project name, a project milestone, project cost, a timeline for a project, project planning information, resources that will be used in the project, responsible parties, project definition, project owner information such as an authority or a public sector institution or organization. Project data may also be a web link to an external web page or any other social network that is further describing the project.

The project data being associated with a creation of project or registration of an interest in an existing created project. The project data input from the user is indicating that the project is related to an existing created issue and aims to address the identified societal issue.

The method further comprising linking the project with the issue S6 by utilizing data input from the user that is indicating that the project is related to an existing created issue and storing the link association in a memory 101 in the electronic device 10, 30, 40, 50 and displaying the project data S7 via the graphical user interface 100 and displaying the link association between the project and the issue S8 via the graphical user interface 100.

A user of the method can hence e.g. get information about a certain societal issue and the projects that are associated with the issue in a simplified and transparent way. The user can also create an issue and/or a project that is related to an issue. This enables a structured and organized way to associate issues and projects. The link association that is displayed helps users to find and be updated about related issues, projects and events. The link association can be displayed to the user via the graphical user interface 100 in form of a text describing the association. The link association can also be an icon or image indicating the existence of a link. The link association can be a so called hyperlink, e.g. a clickable word that links the user to another web page or document or any other content.

According to some aspects of the disclosure the method further comprising detecting an event data input S9 from a user via the graphical user interface 100, the event data input associated with a creation of an event that is related to the issue and/or the project and displaying the event data S10 via the graphical user interface 100 and enabling any user to register, via the graphical user interface 100, an interest in following, and being updated on information relating to the event. The event data can e.g. be a date, place and/or text. Event data can also be e.g. an open invitation to massively-linked users for a request for meeting. The user register an interest in following, i.e. the user choose to see any data that is posted relating to the event. A user can follow plural events. A user of can hence get information about events that are related to projects and/or issues. This enables a structured and organized way to associate issues, projects and events. A user can also stop following an event by, via the graphical user interface 100, un-register i.e. a wish not to follow via the graphical user interface 100 and not get any updates on information relating to the event.

According to some aspects of the disclosure the method further comprising detecting an update data input (S11) of the issue data, the project data and/or the event data from a user via the graphical user interface 100, the update data input being associated with a updating of information of the issue data, the project data and/or the event data and at least one of the issue data, the project data and/or the event data being associated with each other and storing the update data input in a memory 101 at the electronic device. The update data input can be any update or adding/deleting data of already existing data by any user. It can also be an update by the user that has created a certain issue, project and/or event. Hence, a user of the method can input an update of the issue, project and/or the event via the graphical user interface 100 at any time and the update data is maintained in a memory 101 of the electronic device 10, 30, 40, 50 for further processing.

According to some aspects of the disclosure the method further comprising initiating communication S12 of the issue data, project data and/or event data from the electronic device 10, 30, 40, 50 to any user. A user can subscribe to receive information e.g. by registering an interest in a certain issue, project and/or event. A user can also be the creator of certain data, project data and/or event and therefore receive information that is communicated. The communication hence enables a user to be updated on issue data, project data and/or event data that the user is interested in.

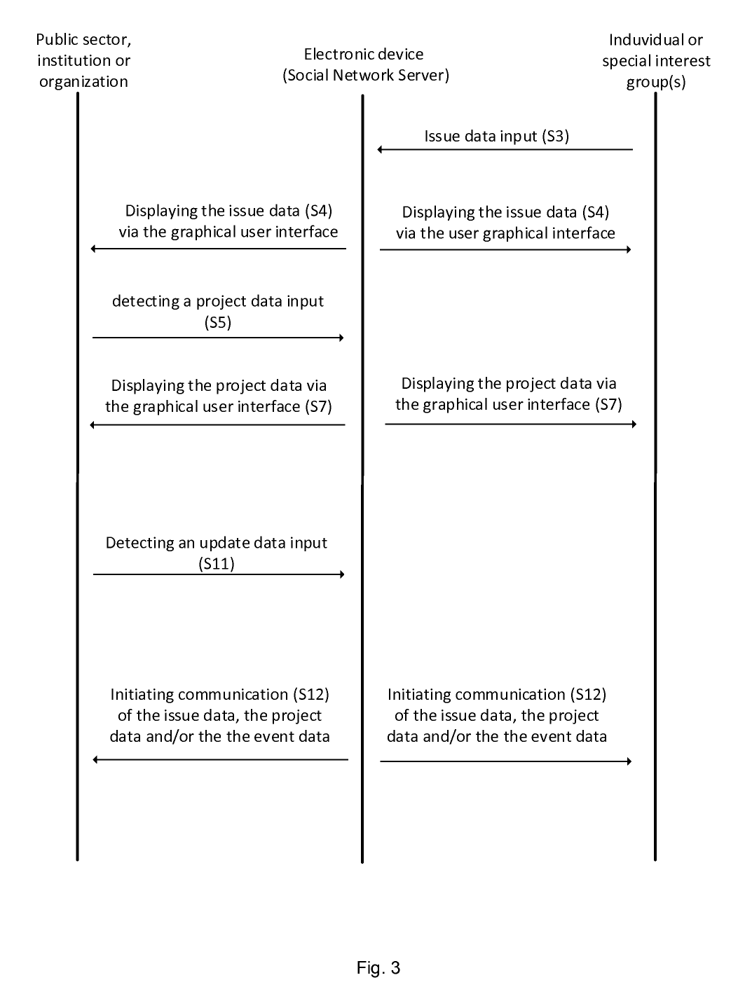

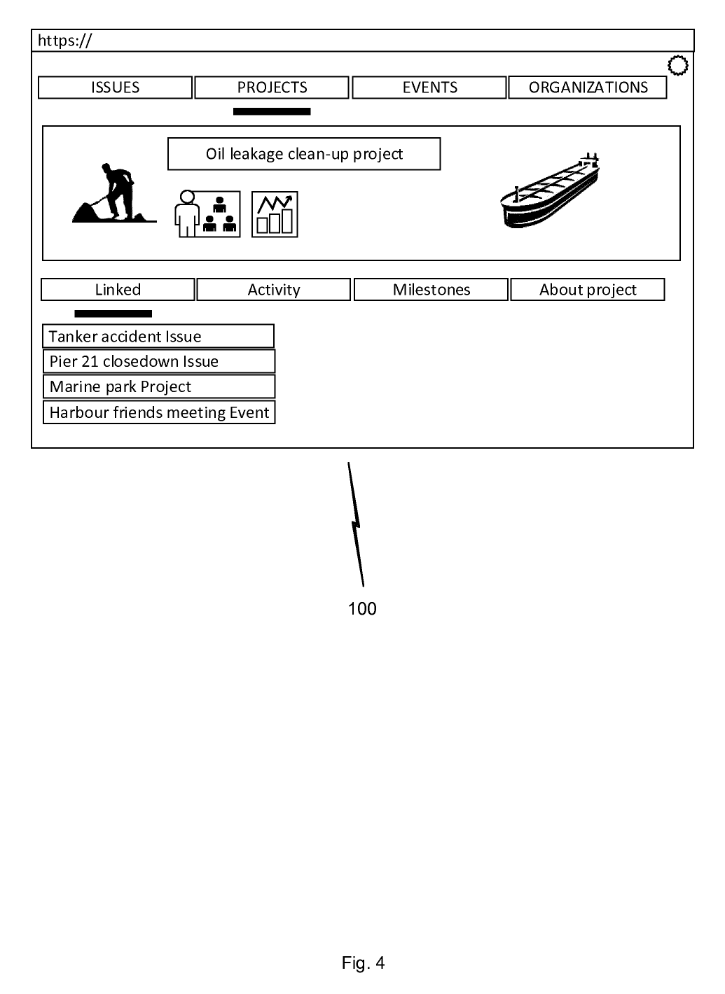

A use case of the disclosure will now be described with help from FIG. 3 and FIG. 4. FIG. 3 illustrates how data is inputted and communicated according to some aspects of the disclosure. FIG. 4 illustrates a graphical user interface 100 according to some aspects of the disclosure.

In the example in FIG. 3 an electronic device 10 in form of a social network server is used to receive issue data input S3. In this example the issue data input is information regarding a tanker that is leaking oil in a bay area close to a city. An individual that has observed this disaster creates the issue called “Tanker accident Issue” using a tablet 50 connected to the social network server 10. The social network server 10 is processing the issue data and displaying the issue data S4 via a graphical user interface 100 that can be accessed by any electronic device 10, 30, 40, 50. Any user, such as an individual citizen, a person, or a special interest group but also an authority or a public sector institution or organization or any stakeholder can now see the issue via a graphical user interface 100 generated by the social network server 10. An environmental help organization later creates a project “Oil leakage clean-up project” that is addressing the issue, i.e. the “Tanker accident Issue”. The social network server 10 is hence detecting a project data input S5. The user that is creating the “Oil leakage clean-up project” is indicating via the graphical user interface 100 when creating the project that it is linked to the “Tanker accident Issue”. The social network server 10 is detecting the project data input, processing the data, and linking the “Oil leakage clean-up project” with the “Tanker accident Issue” and storing the link association in a memory 101. The social network server 10 is processing the project data and displaying the project data S7 via a graphical user interface 100. Any user can now see the project “Oil leakage clean-up project” created by the environmental help organization via a graphical user interface 100 generated by the social network server 10. Later a user, in form of a public sector institution, discovers the “Oil leakage clean-up project” that has been added by the environmental help organization. The public sector institution decides to support the environmental help organization and responds via the social network server 10 to needs of resources that is described by the environmental help organization in the “Oil leakage clean-up project”. The social network server 10 is hence detecting an update data input S11 to the “Oil leakage clean-up project”. Instantly the update is made, the social network server 10 is processing the data and initiates communication S12 of the project data. The receiver of the update data may be any user or users that subscribe to updates relating to e.g. the “Tanker accident Issue” or the “Oil leakage clean-up project”. Sending a notification or initiating communication may include Initiating a communication interface between e.g. the public sector institution or organization and the individual or special interest group stakeholder based on the issue, project or event data.

The public sector institution also creates its own project that is addressing long term objectives to the “Tanker accident Issue”. They call their project the “Marine park Project”. The social network server 10 is hence detecting a project data input S5, in that is also indicating that the “Marine park Project” is related both to the “Tanker accident Issue” and the “Oil leakage clean-up project”. The social network server 10 stores the link associations in a memory 101.

A user that is an individual citizen of the city then creates an Event “Harbour friends meeting Event” that is associated with “Oil leakage clean-up project”, “Tanker accident Issue” and the “Marine park Project” that is open for anyone and displayed via the graphical user interface 100. In other words, the social network server 10 is detecting an event data input from the user via the graphical user interface 100, the event data input is associated with a creation of an event that is related to the issue and/or the project and displaying the event data via the graphical user interface 100 and enabling any user to register, via the graphical user interface 100, an interest in following, and being updated on information relating to the event. A user of the method can hence get information about events that are related to projects and/or issues. This enables a structured and organized way to associate issues, projects and events.

Further aspects of the disclosure will now be described without figures.

To visualize e.g. the progress of a project, issue and/or event, the issue data, project data and/or event data can be visual and/or audio-visual. According to some aspects of the disclosure the method further comprising initiating communication of the issue data, project data and/or event data from the electronic device 10, 30, 40, 50 to any user, the issue data, project data and/or event data comprising visual data such as video, live streamed video or television, images or any visual media. This enables any user to see e.g. changes and updates. The visual data can be either in real-time e.g. via a live streamed video or it can be a recorded video. For example a user can use a web camera or a smartphone to share visual data. A user can also share visual data by linking to visual data that is present in another social media platform or video platform, like Facebook or Youtube.

Before making data available to the public, users can choose to restrict the data and make it available only to certain users. The purpose for doing so can be that plural users may first want to agree about e.g. how a certain project is organized. This enables e.g. project communities to propose a project privately before making the project public to a larger user group. According to some aspects of the disclosure the method further comprising initiating communication of the issue data, project data and/or event data from the electronic device 10, 30, 40, 50 to a restricted predefined group of users. Hence only certain users can see the data. In one example before publishing data a user can get asked if data should be shared to all users or to a restricted group of users. This could also be in a settings menu. One user can invite another user to share data with. Plural users can create closed group of users. In one example data can remain only available for certain users, e.g. an internal project page, and some goals, will only be accessible by the project group members while other data is made available for any user.

In order to process and manage data it needs to be stored in a memory 101. A memory 101 can be local in the electronic device 10, 30, 40, 50 or remote in e.g. a network server. Data can also be shared between plural users and stored in plural electronic devices 10, 30, 40, 50. According to some aspects of the disclosure the method further comprising storing the issue data, the project data and/or the event data and any update data input related to such data, in a memory 101 at the electronic device 10, 30, 40, 50. The data is hence retained for further processing.

The disclosure introduces a method, e.g. at a social media platform, for enabling to exchange of current project-related information between any users situated at or around the location of said project and other project stakeholders and/or the project administrators, where the project-related information is in the form of text, images or video.

More specifically, in one example the disclosure introduces a method for detecting and collecting data shared by project stakeholders located in the vicinity of said project, for the purposes of providing real-time feedback on project progress or development in the form of crowd-based monitoring.

Any user can register a profile to show other users who that user is. A user can define interests, personal data, gender, contact information, family members, school, company, web-links, e-mail, pictures etc. This information is in one example stored in the memory 101 of the electronic device 10, 30, 40, 50 or in a remote server. A user can invite other users to create communities, comprising plural users. A user can “follow” other users and data created by the other users. The user can for example be an individual citizen (a person) or a special interest group but also an authority or a public sector institution or organization or any stakeholder etc.

According to some aspects of the disclosure any user, such as an organization, can create a home page and provide information about the organization itself, about projects, events and issues of interest to the organization and its followers. Any user can follow the organization and get updates whenever something happens. To follow an organization and get updates whenever the organization publishes new information any user can select, via the graphical user interface 100, to follow that organization.

According to some aspects of the disclosure the method further comprising initiating communication of the issue data, the project data and/or the event data from the electronic device 10, 30, 40, 50 to the public sector organization, institution or official body and/or the individual or special interest group stakeholder. The communication of the data to different users enables transparent crowd monitoring of societal issues, projects and events. A user of the method can hence e.g. get information about a certain societal issue and the projects that are associated with the issue in a simplified and transparent way.

According to some aspects of the disclosure the method further comprising initiating communication of the issue data, the project data and/or the the event data from the electronic device 10, 30, 40, 50 to any social media platform or digital channel. This means that data can be processed and used in other platforms such as Facebook, LinkedIn or Twitter.

In one example any data, e.g. any issue data, project data and/or event, can be collected and stored at the electronic device 10, 30, 40, 50 for further processing. The data can be used to create intelligent reports. Reports can in one example use geographic data on projects, issues and events.

Any user, or a plurality of users in e.g. user communities, can in one example share ideas with other users or e.g. an organization. This enables organizations to receive ideas or crowdsource for ideas. In one example the organization can get direct feedback from a group of its users. In one example an organization can create a petition and set the petition goals and e.g. a number of signatures required for an action to take place. Hence in one aspect of the disclosure the method enables a user to receive petitions, suggestions, and/or ideas. A user that is interested in e.g. a particular issue can follow the issue and get update information regarding that issue. A request to follow that issue can include a request for any new update information regarding that particular issue. Further, in one example a user can not only get update information regarding a particular issue itself but also get update information with respect to any other issue or project and/or any event relating to that particular issue. According to some aspects of the disclosure the method further comprising detecting an information request data inputted by a user via the graphical user interface 100, the user requesting to be updated on information relating to an issue, a project and/or an event and registering the information request data and storing the information request data in a memory 101 at the electronic device 10, 30, 40, 50 and initiating communication of information to a user relating to requested data relating to an issue, a project and/or an event. A user can hence request to be registered in order to receive information of interest relating to an issue, a project and/or an event. The electronic device 10, 30, 40, 50 can communicate the requested information accordingly.

According to some aspects of the disclosure a sensor 104 of the electronic device 10, 30, 40, 50 is a GPS receiver for determining the geographical position and for providing position data to the electronic device 10, 30, 40, 50. The position data can be used to earmark or tag the issue data, project data and/or event data generated by a user. In one example the position data is requested to be inputted by the user via the graphical user interface 100. In one example the position data is provided to the electronic device 10, 30, 40, 50 by the GPS receiver to earmark or tag issue data, project data and/or event data generated by a user. According to some aspects of the disclosure the method further comprising detecting position data and linking issue data, project data and/or event data with position data and storing the link association in a memory 101 in the electronic device 10, 30, 40, 50. With this information a user can e.g. get data related to an issue, project and/or event at a certain location. The position can e.g. be the user's current position or any position. According to some aspects of the disclosure the method further comprising storing the positioning data in a memory 101 at the electronic device 10, 30, 40, 50.

In order to find and issues, projects and events and to make them more visible, is to display the issues, projects and events to a user via a graphical user interface 100 based on their geographic location. In one example a graphical user interface 100 in form of a map is used to present the issues, projects and events around a certain geographic location. A user can in one example search for a certain issue, project and/or event based on the geographic location. The geographic location can either be the actual geographic location of a electronic device 10, 30, 40, 50 or a location specified by the user. According to some aspects of the disclosure the method further comprising detecting a search query inputted by a user via the graphical user interface 100, the search query is either related to a specific issue data, project data and/or event data or the search query is based on a position data for a certain geographic location for finding any issue data, project data and/or event data in relation to the geographic location. Then processing the search query input and retrieving data from the memory 101 of the electronic device 10, 30, 40, 50 and displaying a search result via the graphical user interface 100 based on the search query input. Hence, a user can find relevant issue data, project data and/or event data using either keywords or position data.

A user may desire to get updated on any issues, projects and events in the surroundings of a certain geographic location. In one example the user is at the actual geographic location and the GPS receiver of the electronic device 10, 30, 40, 50 is determining the geographical position and provides the position data. In one example the user is inputting any position data via the graphical user interface 100. According to some aspects of the disclosure the method further comprising detecting position data and determining, by using the position data, if any issue data, project data and/or event data exists that is associated with the position data or within a predetermined distance from the geographic location defined by the position data. Further the method comprising collecting any existing issue data, project data and/or event data dependent on the position data and initiating communication of the existing issue data, project data and/or event data to any user, public sector organisation, institution or official body and/or an individual or special interest group stakeholder and displaying in the graphical user interface 100, the issue, project and/or event on a map. This means that any user can get updates based the geographic location of an issue, project and/or event. According to one aspect of the disclosure the collection of any existing issue data, project data and/or event data dependent on the position data is performed on a regular basis and followed by communication of the existing issue data, project data and/or event data to any user.

The disclosure further proposes an electronic device 10, 30, 40, 50 for social societal information sharing configured for generating a graphical user interface 100, and for providing user interaction. The electronic device 10, 30, 40, 50 comprising a memory 101 and a communication interface 102 for providing communication with at least one server. The electronic device 10, 30, 40, 50 further comprising a processing circuitry 103 configured to cause the electronic device 10, 30, 40, 50 to generate a graphical user interface 100 for displaying societal social media information and for providing user interaction. The processing circuitry 103 is further configured to cause the electronic device 10, 30, 40, 50 to display the graphical user interface 100 the graphical user interface 100. The processing circuitry is further configured to cause the electronic device 10, 30, 40, 50 to detect an issue data inputted by a user via the graphical user interface 100, the issue data input associated with a creation of an issue, or registration of an interest in an existing created issue, where the issue is relating to an identified societal issue and display the issue data via the graphical user interface 100. The processing circuitry 103 is further configured to cause the electronic device 10, 30, 40, 50 to detect a project data inputted by a user via the graphical user interface, the project data being associated with a creation of project or registration of an interest in an existing created project, the project data input from the user is indicating that the project is related to an existing created issue and aims to address the identified societal issue. The processing circuitry 103 is further configured to cause the electronic device 10, 30, 40, 50 to utilize data input from the user that is indicating that the project is related to an existing created issue and linking the project with the issue and store the link association in a memory 101 in the electronic device 10, 30, 40, 50 and display the project data via the graphical user interface 100, and further to display the link association between the project and the issue via the graphical user interface 100. A user of the method can hence e.g. get information about a certain societal issue and the projects that are associated with the issue in a simplified and transparent way. The user may also create an issue and/or a project that is related to an issue. This enables a structured and organized way to associate issues and projects.

The electronic device 10, 30, 40, 50 is configured to perform any of the aspects of the methods described above.

According to some aspects of the disclosure a method is described and the method, at an electronic device comprising:
generating a graphical user interface for displaying societal social media information and for providing user interaction
displaying the graphical user interface, the graphical user interface being adapted for being displayed via a web interface or a mobile application interface
detecting an issue data input from a user via the user interface, the issue data input associated with a creation of an issue, or registration of an interest in an existing created issue, where the issue is relating to an identified societal issue or need
storing the issue data in a memory at the electronic device
displaying the issue data via the user interface
initiating communication of the issue data from the device to the public sector organisation, institution or official body and/or the individual or special interest group stakeholder
detecting a project data input from a user via the user interface, the project data associated with a creation of project or registration of an interest in an existing created project where the project is relating to the issue and aims to address the issue.
storing the project data in a memory at the electronic device
displaying the project data via the user interface
initiating communication of the project data from the device to the public sector organisation, institution or official body and/or the individual or special interest group stakeholder
linking the issue data with the associated project data and storing the association in a memory in the device
displaying the association via the user interface
detecting an event data input from a user via the user interface, the event data input associated with a creation of an event that is related to the issue data and/or the project data
storing the event data in a memory at the electronic device
displaying the event data via the user interface and enabling any user to register, via the user interface, an interest in following, and being updated on information relating to, the event
initiating communication of the event data from the device to the public sector organisation, institution or official body and/or the individual or special interest group stakeholder
detecting an update event data input from a user via the user interface, the update event data input associated with a updating of information associated to the event that is related to the issue data and/or the project data
storing the update event data input in a memory at the electronic device
Initiating communication of the event data from the device to any user that has registered an interest in the event.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method, at an electronic device, for social societal information sharing comprising:
generating a graphical user interface for displaying societal social media information and for providing user interaction via the graphical user interface
displaying the graphical user interface
detecting an issue data input inputted by a user via the graphical user interface, wherein the issue data input is associated with one of a creation of an issue, or registration of an interest in an existing created issue, wherein the issue is relating to an identified societal issue
displaying the issue data via the graphical user interface
detecting a project data input inputted by a user via the graphical user interface, the project data input is associated with one of a creation of a project or registration of an interest in an existing created project, wherein the project data input from the user is indicating that the project is related to an issue and aims to address or contribute to the issue
linking the project with the issue by utilizing data input from the user that is indicating that the project is related to an existing created issue and storing the link association in a memory in the electronic device
displaying the project data via the graphical user interface
displaying the link association between the project and the issue via the graphical user interface.

2. The method according to claim 1, further comprising:
detecting an event data input from a user via the graphical user interface, the event data input is associated with a creation of an event that is related to the issue and/or the project
displaying the event data via the graphical user interface and enabling a user to register, via the graphical user interface, an interest in following, and being updated on information relating to, the event.

3. The method according to claim 1, further comprising:
initiating communication of the issue data, project data and/or event data from the electronic device to any user.

4. The method according to claim 1, wherein:
the issue data, project data and/or event data comprising visual data such as video, live streamed video or television, images or any visual media.

5. The method according to claim 1, further comprising:
initiating communication of the issue data, project data and/or event data from the electronic device to a restricted predefined group of users.

6. The method according to claim 1, further comprising:
storing the issue data, the project data and/or the event data and any update data input related to such data, in a memory at the electronic device.

7. The method according to claim 1, further comprising:
detecting an update data input of the issue data, the project data and/or the event data from a user via the graphical user interface, the update data input being associated with a updating of information of the issue data, the project data and/or the event data and at least one of the issue data, the project data and/or the event data being associated with each other
storing the update data input in a memory at the electronic device.

8. The method according to claim 1, further comprising:
initiating communication of the issue data, the project data and/or the event data from the electronic device to a public sector organisation, institution or official body and/or an individual or special interest group stakeholder.

9. The method according to claim 1, further comprising:
initiating communication of the issue data, the project data and/or the event data from the electronic device to any social media platform or digital channel.

10. The method according to claim 1, further comprising:
detecting an information request data input from a user via the graphical user interface, the user requesting to be updated on information relating to an issue, a project and/or an event
registering the information request data and storing the information request data in a memory at the electronic device
initiating communication of information to a user relating to requested data relating to an issue, a project and/or an event.

11. The method according to claim 1, further comprising:
detecting position data
linking issue data, project data and/or event data with the position data and storing the link association in a memory in the electronic device.

12. The method according to claim 1, further comprising:
detecting a search query inputted by a user via the graphical user interface, the search query is either related to a specific issue data, project data and/or event data or the search query is based on a position data for a certain geographic location for finding any issue data, project data and/or event data in relation to the geographic location
processing the search query input and retrieving data from the memory of the electronic device
displaying a search result via the graphical user interface based on the search query input.

13. The method according to claim 1, further comprising:
detecting position data
determining, by using the position data, if any issue data, project data and/or event data exists that is associated with the position data or within a predetermined distance from the geographic location defined by the position data
collecting any existing issue data, project data and/or event data dependent on the position data
initiating communication of the existing issue data, project data and/or event data to any user, public sector organisation, institution or official body and/or an individual or special interest group stakeholder displaying, in the graphical user interface, the issue, project and/or event on a map.

14. An electronic device for social societal information sharing configured for generating a graphical user interface, and for providing user interaction, the electronic device comprising:
a memory
a communication interface for providing communication with at least one server
a processing circuitry, configured to cause the electronic device to:
generate a graphical user interface for displaying societal social media information and for providing user interaction
display the graphical user interface
detect an issue data inputted by a user via the graphical user interface, the issue data input associated with one of a creation of an issue or registration of an interest in an existing created issue, where the issue is relating to an identified societal issue
display the issue data via the graphical user interface
detect a project data inputted by a user via the graphical user interface, the project data being associated with a creation of project or registration of an interest in an existing created project, the project data input from the user is indicating that the project is related to an existing created issue and aims to address the identified societal issue.
utilize data input from the user that is indicating that the project is related to an existing created issue and linking the project with the issue and store the link association in a memory in the electronic device
display the project data via the graphical user interface
display the link association between the project and the issue via the graphical user interface.
